(19) United States
(12) Patent Application Publication
(10) Pub. No.: US 2009/0168126 A1
(43) Pub. Date: Jul. 2, 2009

(54) Light Emitting Unit, Lighting Apparatus and Image Reading Apparatus

(75) Inventors: Tomihisa Saito, Tokyo (JP); Masahide Wakisaka, Tokyo (JP); Hiroyuki Nemoto, Tokyo (JP); Naofumi Sumitani, Tokushima (JP)

Correspondence Address: CARRIER BLACKMAN AND ASSOCIATES, 24101 NOVI ROAD, SUITE 100, NOVI, MI, 48375, US

(73) Assignees: Nippon Sheet Glass Co., Ltd., Minato-ku, Tokyo (JP); NICHIA Corporation, Anan-shi, Tokushima (JP)

(21) Appl. No.: 12/224,281

(22) PCT Filed: Feb. 19, 2007
(86) PCT No.: PCT/JP2007/052925

§ 371 Date: Oct. 17, 2008

(30) Foreign Application Priority Data
Feb. 22, 2006 (JP) 2006-044620
Feb. 22, 2006 (JP) 2006-044639

(51) Int. Cl. H04N 1/04; F21V 29/00

(52) U.S. Cl. 358/496; 362/218

(57) ABSTRACT

There are provided a light emitting unit in which temperature increase due to heat generated in a light emitting element is suppressed to enhance light emission efficiency, a linear illumination device in which the light emitting unit is incorporated, and a contact-type image sensor and an image scanner in which the linear illumination device is incorporated. A lead frame 23 in the light emitting unit has an extension 29. The extension 29 is folded along a case 12, and a plate-shaped heat dissipater 30 is connected to the extension 29. The connection is carried out by forming holes 29a and 30a in the extension 29 and the heat dissipater 30, respectively, and engaging a protrusion 31 formed on the case 12 in the holes 29a and 30a. The extension 29 thus comes into tight contact with the heat dissipater 30 and is fixed thereto. The heat dissipater 30 is made of a good thermally conductive material, such as copper, and formed separately from the lead frame 23.

### TECHNICAL FIELD

The present invention relates to a light emitting unit, a linear or panel illumination device in which the light emitting unit is incorporated, and an image scanner in which the illumination device is incorporated.

### BACKGROUND ART

Any image scanner, such as a facsimile, a copier, and an image scanner, includes a linear illumination device that linearly illuminates the surface of a source document across a primary scan range. The linear illumination device is configured in such a way that a light emitting unit is disposed at an end (one end or both ends) of a rod-shaped or plate-shaped transparent light guiding member and the light incident on the end of the light guiding member exits through an exit surface provided along the longitudinal direction while being repeatedly reflected off inner surfaces of the light guiding member.

In the structure of a typical light emitting unit, as shown in FIG. 19, a lead frame 100 and lead terminals 101 are held in a resin mold 102 in such a way that they do not come into contact with one another. Light emitting elements (LEDs) 104, . . . are mounted on the lead terminals 101 exposed through an opening 103 provided in the resin mold 102. The light emitting elements 104 are then connected to the lead frame 100 with gold wires 105.

In recent years, there has been a need to increase the speed at which an image is read. To this end, it is necessary to increase the luminance of the illumination device and hence increase the luminance of the illumination light that illuminates the surface of a source document to be read. However, when the current conducting in the light emitting elements is increased in order to increase the luminance of the illumination device, the light emission is enhanced, but at the same time, the junction temperature increases (the light emitting elements themselves generate heat). The light emission efficiency and the lifetime of the light emitting elements decrease accordingly.

To solve the above disadvantages, Patent Document 1 proposes a structure in which a plate-shaped lead frame has an extension that serves as a heat dissipater. When the area of the heat dissipater is increased particularly to enhance the heat dissipating efficiency, the larger heat dissipater may interfere with other parts. To address the problem, FIG. 6 in Patent Document 1 discloses a configuration in which the heat dissipater is folded along a case in which a transparent light guiding member is housed.

In general, the light conversion efficiency of a light emitting unit mounted on an illumination device depends on the temperature of the atmosphere to which fluorescent substances are exposed. The efficiency lowers when the temperature of the atmosphere rises, and the resistance of the light emitting unit lowers when the temperature rises. The magnitude of current thus increases when constant-voltage driving is employed. To avoid such a situation, constant-current driving is typically employed to stabilize the luminance. In consideration of the Arrhenius scaling law (when the temperature decreases by 10 degrees, the lifetime doubles), it is known that lowering the temperature of the light emitting unit extends the lifetime.

In an LED-based light emitting unit in an apparatus used for illumination purposes, the conducting current is within the rating. Therefore, heat that may affect the lifetime will not be generated. In an image scanner, however, it is conceivable to increase the magnitude of current flowing through an LED to increase the luminance of the illumination device when image reading is conducted more quickly. Since an LED is a semiconductor device, nonradiative recombination more likely occurs at higher temperatures, which lowers the light emission efficiency. It is therefore necessary to appropriately dissipate heat generated in the light emitting element (LED) into the atmosphere and prevent the temperature of the light emitting element (LED) from excessively increasing.

In related art, as shown in FIG. 26, a plate-shaped lead frame 201 in a light emitting unit 200 has an extension 202. The plate-shaped lead frame 201 also has a heat-dissipating terminal 209. Heat generated in light emitting elements 200a, 200b, and 200c is directly transferred to the lead frame 201. The light emitting elements 200a, 200b, and 200c are connected to power-feeding lead terminals (cathode terminals) 204a, 204b, and 204c, respectively.

FIG. 27 is a circuit wiring diagram of an exemplary mechanism of related art that dissipates heat generated in LEDs connected in the common cathode configuration. A heat dissipating plate 206 is grounded to a signal ground 205 shared by a power supply 208 and current control circuits 207a to 207c. The anode terminal of the power supply 208 supplies power to the current control circuits 207a to 207c, and the output terminals of the current control circuits 207a to 207c are respectively connected to the anodes of the light emitting elements 200a, 200b, and 200c. Further, the cathodes of the light emitting elements 200a, 200b, and 200c are connected to the signal ground 205 in the common cathode configuration. Heat generated in the light emitting elements 200a, 200b, and 200c is transferred to the heat dissipating plate 206 through the lead frame on which the light emitting elements 200a, 200b, and 200c are mounted and cooled by air. As described above, the heat dissipating plate 206 is connected to the signal ground 205 as are the cathodes of the light emitting elements 200a, 200b, and 200c, so that the heat dissipating plate 206 and the cathodes have the same potential.

FIG. 28 is a circuit wiring diagram of an example of related art in a case where the heat dissipating plate 206 is connected to the anodes of the LEDs connected in the common anode configuration so that the heat dissipating plate 206 and the anodes have the same potential.

FIG. 29 shows exemplary temperature characteristics of the forward voltage V_{F}. In FIG. 29, the magnitude of LED current is used as a parameter. The characteristics are similar to measured characteristics data for an equivalent of, for example, an LED made by Nichia Corporation (NSPE510S). In FIG. 29, the magnitude of current flowing through the LED is used as a parameter, and three parameter values are set (5 mA, 10 mA, and 30 mA). For each of the parameter current magnitudes, the ambient temperature is changed from −30° C. to +80° C. and the forward voltage V_{F} is measured. As apparent from FIG. 29, the forward voltage V_{F} of the light emitting element (LED) versus temperature is characterized in that the forward voltage V_{F} at the power supply terminal of the LED and hence the relative luminous intensity tend to decrease as the temperature rises. Further, the forward voltage V_{F} tends to be more easily affected by the environmental temperature when the magnitude of current flowing through the LED has a larger value. When a large magnitude of current flows, the light emitting unit itself generates heat and the temperature thereof abruptly increases. In this case, since the internal resistance decreases, the magnitude of current varies when a constant-voltage control circuit is used. To eliminate the influence of the variation in the magnitude of current, especially when the LED is driven by a large magnitude of current, a constant-current control circuit is typically used to control the luminance of the LED.

As a technology similar to the example of related art described above, Patent Document 1 described above discloses an example in which light emitting elements (LEDs) are connected to a common lead frame in the common anode configuration and heat generated in the light emitting elements (LEDs) is dissipated through a heat-dissipating dummy terminal extending from the common lead frame. Patent Document 1 also discloses a structure in which the lead frame connected to the anodes of the light emitting elements in the common anode configuration is extended to expose it to the outside and the extension is folded along a case of a linear illumination device.

Patent Document 2 describes a configuration in which each of the anode terminals of light emitting elements connected in the common cathode configuration is connected to a signal ground (ground side) for a current control circuit and a heat dissipating plate is connected to not only the signal ground for each of the drive circuits of the light emitting elements (LEDs) but also a frame ground of a light emitter. In this configuration, the surface area of a heat-dissipating metallic portion as a lead member of each of the light emitting elements (LEDs) is larger than the surface area of a molded member of the light emitting elements (LEDs), and the heat-dissipating metallic portion is folded by 45 to 135 degrees with respect to the molded member toward the side where the light emitting elements (LEDs) are mounted. In this way, heat generated in the light emitting elements (LEDs) is efficiently dissipated.

Patent Document 1: Japanese Patent Laid-Open No. 2005-217644

Patent Document 2: Japanese Patent Application No. 2005-086291

According to Patent Document 1 described above, increase injunction temperature of the light emitting elements can be reduced, whereby light emission efficiency is improved and the lifetime is extended. However, the following two problems remain.

One of the problems relates to lead frame fabrication. FIG. 20 shows a lead frame before it is cut out from a metallic plate. A longer heat dissipater results in a longer metallic plate, leaving a wider area that will be wasted after the lead frame is cut off.

The other problem is unstable initial light emission. Although providing the heat dissipater can lower the junction temperature to a predetermined value or smaller and improve the light emission efficiency, it takes longer for the junction temperature to reach the predetermined value and achieve the state of equilibrium. The light emission during this phase becomes unstable.

As described in Patent Document 1, extending a ground terminal (common) and the heat-dissipating dummy terminal from the lead frame results in static electricity and other noise coming especially from the heat-dissipating dummy terminal connected to the ground terminals (common) of the LEDs because the ground terminal (common) and the heat-dissipating dummy terminal are exposed to the outside. Such noise may break the LEDs, or may affect a CIS signal from a contact-type image sensor when the above structure is used in an image scanner.

Even in Patent Document 2 characterized by heat-dissipating means electrically connected to the light emitting elements (LEDs); the rectangular, metallic lead members made of copper or an alloy primarily containing copper; and the metallic lead member alone or an external heat sink connected thereto used as the heat dissipating means, static electricity and other noise come from the metallic lead members or the external heat sink connected to the same system ground because the ground terminal (system ground) and the heat-dissipating dummy terminal are exposed to the outside. Such noise again may break the LEDs, or may affect a CIS signal from a contact-type image sensor.

### DISCLOSURE OF THE INVENTION

To solve the first problem described above, a first aspect of the present invention according to claim 1 provides a light emitting unit comprising a lead frame on which a light emitting element is mounted, part of the lead frame held in a resin mold, and a heat dissipater that releases heat generated when the light emitting element is energized. The heat dissipater is formed separately from the lead frame, and the heat dissipater is connected to the lead frame directly or via a metallic member.

The heat dissipater is connected to the lead frame or the metallic member mechanically or via a thermally conductive resin sheet, grease, or adhesive. The mechanical connection includes protrusion-recess engagement and fitting. Examples of the thermally conductive resin sheet, grease, or adhesive include a silicone rubber sheet, a silicone grease, and a silicone rubber adhesive.

The first aspect of the present invention also includes a linear or panel illumination device comprising the light emitting unit disposed at an end of a light guiding member, as well as an image scanner comprising the illumination device, a linear image sensor, and a lens array that focuses light reflected off or transmitted through a source document onto the linear image sensor, the illumination device, the linear image sensor, and the lens array assembled a housing case, the housing case moved parallel to the source document to read the source document.

The first aspect of the present invention also includes an illumination device comprising the light emitting unit disposed at an end of a light guiding member, as well as a reduction-type image scanner comprising the illumination device, a linear image sensor, a lens that focuses light reflected off or transmitted through a source document onto the linear image sensor, and a mirror that guides the light reflected off the source document to the lens, the illumination device, the linear image sensor, the lens, and the mirror assembled in an enclosure.

In the case of a linear illumination device, the heat dissipater is preferably disposed along a case for the light guiding member, because the heat dissipater will not interfere with other members. In the case of an image scanner, the heat dissipater is preferably disposed along the housing case for the same reason. Further, in the case of an image scanner, the heat dissipater may protrude outward from the housing case and may be slidably brought into contact with a flame of the image scanner. In this way, the heat dissipating effect is improved.

Another embodiment of the first aspect of the present invention provides a light emitting unit comprising a lead frame on which a light emitting element is mounted, part of the lead frame held in a resin mold, a heat dissipater that releases heat generated when the light emitting element is energized, and a heater disposed in the vicinity of the light emitting element, the heater quickly increasing the junction temperature of the light emitting element to an equilibrium temperature.

A second aspect of the present invention according to claim 12 provides a light emitting unit comprising a lead frame on which at least one light emitting element is mounted, and a heat dissipater that releases heat generated when the light emitting element is energized. The heat dissipater is directly connected to a frame ground provided separately from a signal ground.

The second aspect of the present invention according to claim 13 provides a light emitting unit comprising a lead frame on which at least one light emitting element is mounted, and a heat dissipater that releases heat generated when the light emitting element is energized. The anode of the light emitting element is connected to the anode terminal of a power supply in the common anode configuration, whereas the cathode of the light emitting element is connected to a current control circuit grounded to a signal ground. Heat dissipating means for dissipating heat from the light emitting element is attached to a thermally conductive insulating layer that is then attached to the lead frame on which the light emitting element is mounted. The heat dissipating means is connected to a frame ground electrically insulated from the signal ground.

In the light emitting unit described above, the heat dissipater is formed separately from the lead frame, and the heat dissipater is connected to the lead frame directly or via a metallic member.

Further, a linear or panel illumination device includes the above light emitting unit, and a contact-type or reduction-type image scanner includes the above light emitting unit.

According to the first aspect of the present invention, since the heat dissipater is formed separately from the lead frame, the amount of wasted portions of a metallic plate is reduced when the heat dissipater and the lead frame are cut off.

Further, according to the first aspect of the present invention, since a heater is provided in the vicinity of the light emitting element so that the junction temperature more quickly reaches an equilibrium temperature, the period of unstable light emission can be reduced.

According to the second aspect of the present invention, since the circuit that controls the light emitting unit is connected to the signal ground, and the heat dissipating means insulated from the light emitting unit is connected to the frame ground electrically insulated and spaced apart from the signal ground, the heat dissipating capability of the light emitting unit can be enhanced while malfunctions due to noise is avoided. Therefore, the heat dissipating means will not affect the light emitting unit even when a large magnitude of current having a rated value or greater flows through the light emitting unit, and the brightness of the illumination device can be increased in a stable operation. Further, an image can be read at a speed faster than typical in an image scanner using the illumination device having the heat dissipater.

### BRIEF DESCRIPTION OF THE DRAWINGS

FIG. 1(a) is a cross-sectional view of an image scanner in which a light emitting unit according to a first aspect of the present invention is incorporated, and FIGS. 1(b) and 1(c) show variations of the image scanner;

FIG. 2 is a plan view of a contact-type image sensor incorporated in the image scanner;

FIG. 3 is a perspective view of a linear illumination device in which the light emitting unit according to the first aspect of the present invention is incorporated;

FIG. 4 is a perspective view showing how a lead frame is connected to a heat dissipater;

FIG. 5 shows lead frames before they are cut off;

FIG. 6 shows heat dissipaters before they are cut off;

FIG. 7 is a perspective exploded view showing another example of how a heat dissipater is connected to a lead frame;

FIG. 8(a) is a perspective view showing the shape of the lead frame in the light emitting unit shown in FIG. 7, and FIG. 8(b) shows a variation of FIG. 8(a);

FIG. 9 shows lead frames used in the light emitting unit according to the embodiment shown in FIG. 7 before they are cut off;

FIG. 10 shows an example in which a heat dissipater is disposed along a housing case for a contact-type image sensor;

FIG. 11 shows another example in which a heat dissipater is disposed along a housing case for a contact-type image sensor;

FIG. 12 shows another example in which a heat dissipater is disposed along a housing case for a contact-type image sensor;

FIG. 13 shows another example in which a heat dissipater is slidably brought into contact with a frame;

FIG. 14 is a perspective view of a linear illumination device in which a heater is attached to a light emitting element;

FIG. 15 is a cross-sectional view of an image scanner according to another example using a panel illumination device;

FIG. 16 is a perspective view of the panel illumination device to which the first aspect of the present invention is applied;

FIG. 17 is an exploded view of the panel illumination device shown in FIG. 15;

FIG. 18 is an exploded view similar to FIG. 17 but viewed from the side opposite the side from which FIG. 16 is viewed;

FIG. 19 is a front view of a typical light emitting element;

FIG. 20 shows a lead frame integral with a heat dissipater before the lead frame is cut off;

FIG. 21 is a cross-sectional view of an image scanner in which a light emitting unit according to a second aspect of the present invention is incorporated;

FIG. 22 is a perspective view of a linear illumination device in which the light emitting unit according to the second aspect of the present invention is incorporated;

FIG. 23 is a wiring diagram of the light emitting unit and a heat dissipating plate (connected in the common anode configuration) according to the second aspect of the present invention;

FIG. 24 is a wiring diagram of the light emitting unit and the heat dissipating plate (connected in the common cathode configuration) according to another example of the second aspect of the present invention;

FIG. 25 is an exterior view of another example of the light emitting unit according the second aspect of the present invention;

FIG. 26 is an exterior view of a light emitting unit of related art;

FIG. 27 is a wiring diagram of the light emitting unit and a heat dissipating plate (connected in the common cathode configuration) of related art;

FIG. 28 is a wiring diagram of the light emitting unit and the heat dissipating plate (connected the common anode configuration) of related art; and

FIG. 29 shows graphs illustrating temperature characteristics of relative luminous intensity of a light emitting unit (LED).

### BEST MODE FOR CARRYING OUT THE INVENTION

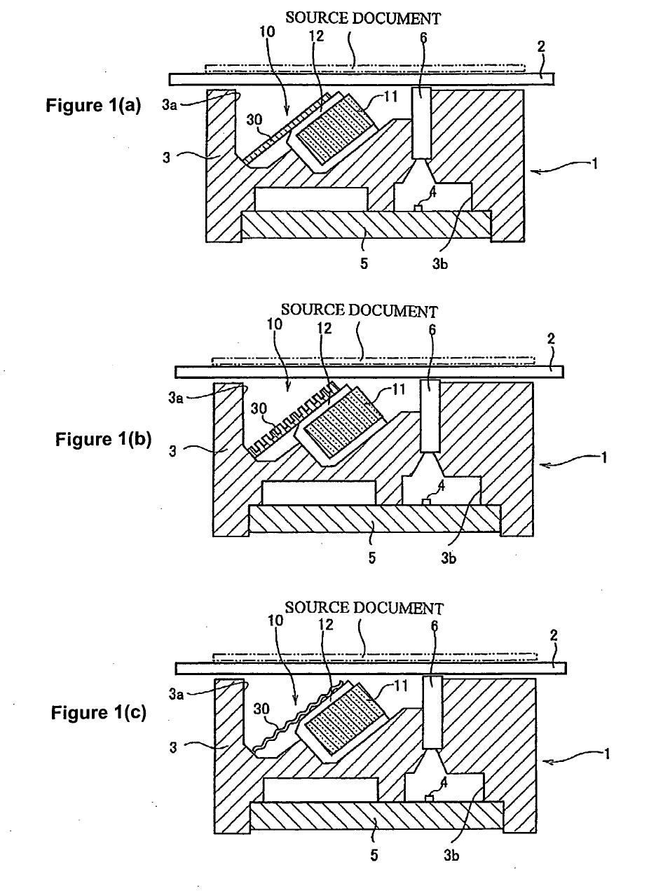

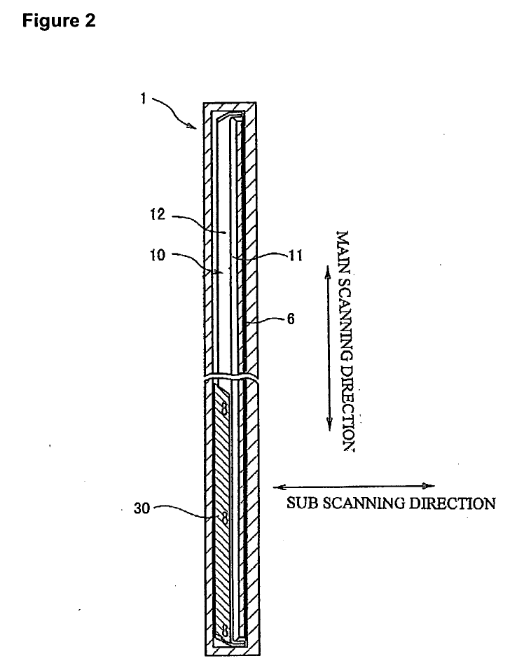

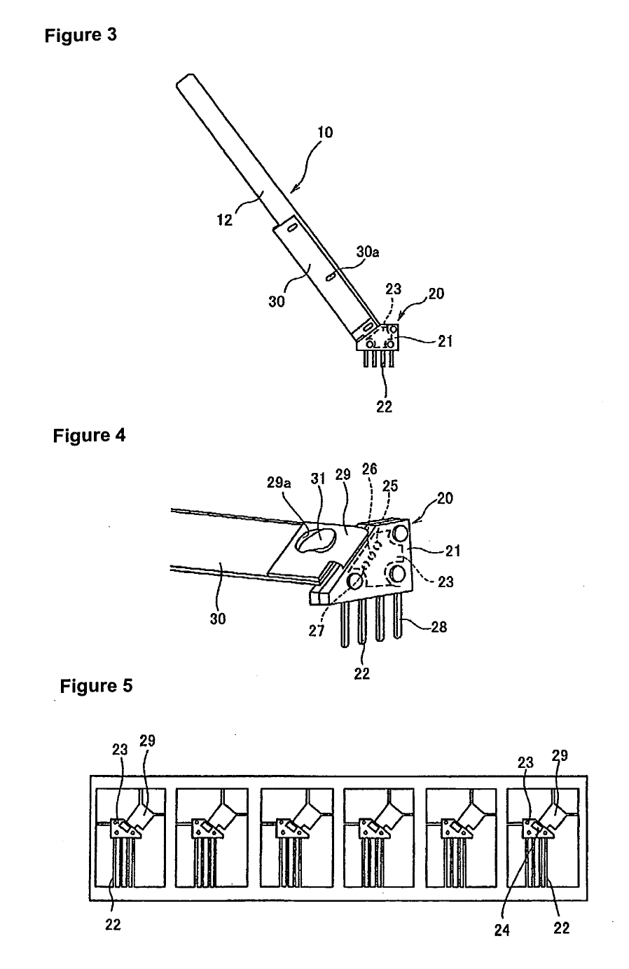

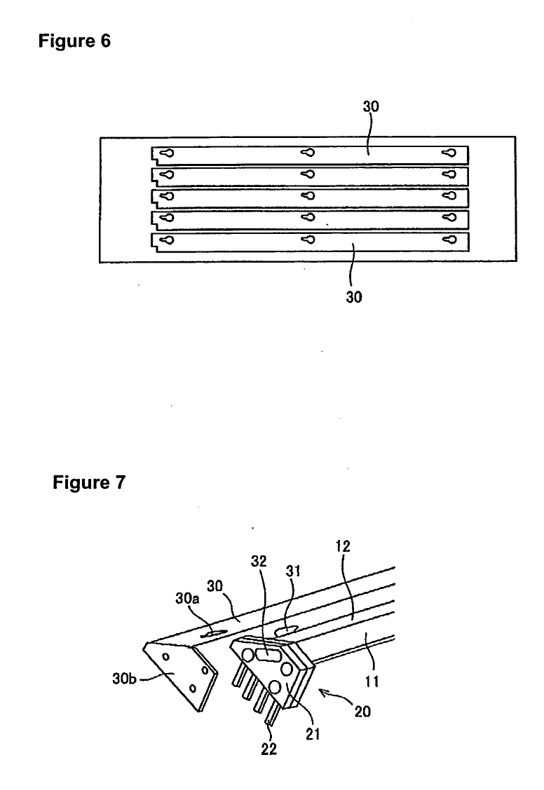

A preferred example of a first aspect of the present invention will be described below with reference to the accompanying drawings. FIG. 1 shows cross-sectional views of an image scanner in which a light emitting unit according to the fist aspect of the present invention is incorporated. FIG. 2 is a plan view of a contact-type image sensor incorporated in the image scanner. FIG. 3 is a perspective view of a linear illumination device in which the light emitting unit according to the first aspect of the present invention is incorporated. FIG. 4 is a perspective view showing how a lead frame is connected to a heat dissipater. FIG. 5 shows lead frames before they are cut off. FIG. 6 shows heat dissipaters before they are cut off.

In the drawings, reference numeral 1 denotes a contact-type image sensor, and reference numeral 2 denotes a glass platen on which a source document is placed. The contact-type image sensor 1 moves parallel to the glass platen 2 and reads the source document. The direction in which the contact-type image sensor 1 moves is a sub scanning direction, and the direction perpendicular to the image sensor moving direction (the longitudinal direction of the contact-type image sensor 1) is a main scanning direction.

The contact-type image sensor includes a housing case (enclosure) 3 in which recesses 3a and 3b are formed. A linear illumination device 10 is disposed in one of the recesses 3a, and a sensor substrate 5 with a photoelectric conversion element (linear image sensor) 4 is attached to the other recess 3b. The housing case 3 further holds a unit magnification imaging lens array 6.

The linear illumination device 10 includes a rod-shaped or plate-shaped, transparent light guiding member 11 made of an acrylic resin that is housed in a white case 12 and a light emitting unit 20 attached to an end of the case 12. In the illustrated example, the light emitting unit 20 is attached to one end of the case 12, but two light emitting units 20 may be attached to both ends of the case 12. The linear illumination device 10 may also be disposed on each of the right and left sides of the lens array 6.

The light emitting unit 20 is fabricated by forming a resin mold 21 into which lead terminals 22 and a plate-shaped lead frame 23 having a larger area than the lead terminals 22 are inserted. The light emitting unit 20 has a window 24 through which light emitting elements are mounted.

A preferable material of the lead frame 23 is phosphor bronze or iron-containing copper. RGB (three primary colors) light emitting elements (LEDs) 25, 26, and 27 are mounted on the portion exposed through the window 24 of the lead frame 23. One electrode of each of the light emitting elements 25, 26, and 27 is connected to the corresponding lead terminal 22 with a gold wire, and other electrode of each of the light emitting elements 25, 26, and 27 is connected to the lead frame 23 with a gold wire. The window 24 is sealed with a transparent resin after the gold wires have been connected. A common terminal 28 extends from the lead frame 23, and the lower ends of the lead terminals 22 and the common terminal 28 described above are fixed with solder into through holes formed in the sensor substrate 5.

The lead frame 23 has an extension 29. The extension 29 is folded along the case 12, and a plate-shaped heat dissipater 30 is connected to the extension 29. The connection is carried out by forming holes 29a and 30a in the extension 29 and the heat dissipater 30, respectively, and engaging a protrusion 31 formed on the case 12 in the holes 29a and 30a. The extension 29 thus comes into tight contact with the heat dissipater 30 and is fixed thereto.

The heat dissipater 30 may be glued to the case 12 with a good thermally conductive material in order to increase heat dissipation efficiency.

The shape of the heat dissipater 30 is not limited to the plate shape shown in FIG. 1(a), but other conceivable shapes include a finned shape shown in FIG. 1(b) and a corrugated-plate shape shown in FIG. 1(c).

The heat dissipater 30 is made of a good thermally conductive material, such as copper, and formed separately from the lead frame 23. FIGS. 5 and 6 show these members before they are cut off. Separately cutting off these members allows the amount of wasted material to be reduced.

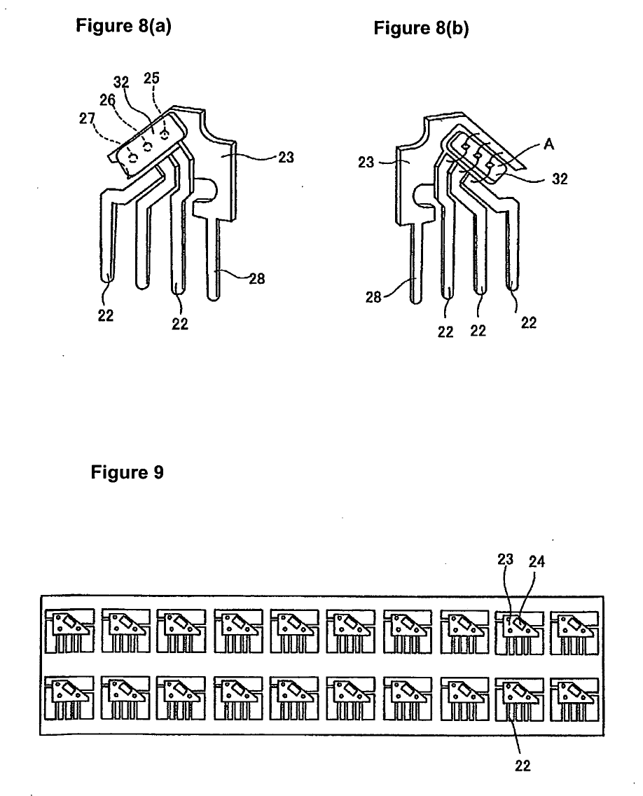

FIG. 7 is a perspective exploded view showing another example of how a heat dissipater is connected to a lead frame. FIG. 8(a) is a perspective view showing the structure of the lead frame 23 in the light emitting unit 20 shown in FIG. 7. FIG. 8(b) shows a variation of FIG. 8(a).

In FIG. 7, a metallic piece 32 made of, for example, copper that excels in thermal conductivity is attached to the portion of the lead frame 23 that is opposite the portion on which light emitting elements (LEDs) are mounted (the outer side in FIG. 7). The metallic piece 32 is exposed to the outside through a hole formed in the resin mold 21. Therefore, when a base end 30b of the heat dissipater 30 is attached to the resin mold 21 in such a way that the base end 30b covers the resin mold 21, the metallic piece 32 comes into contact with the base end 30b of the heat dissipater 30, and heat generated in the light emitting elements (LEDs) is efficiently transferred to the heat dissipater 30.

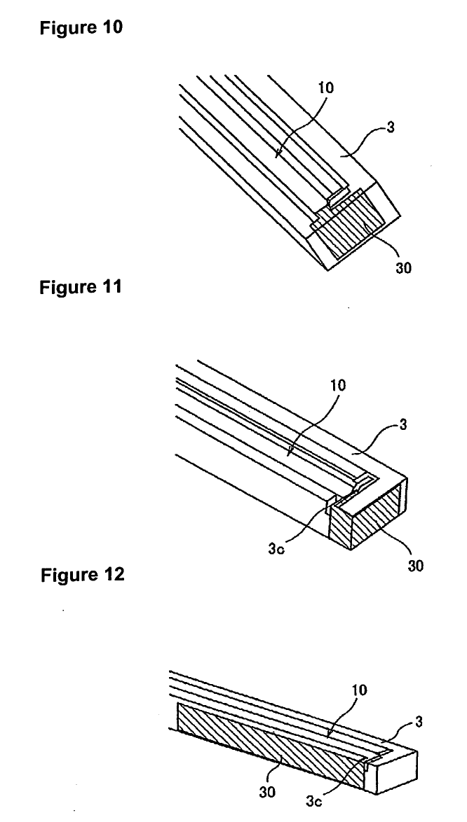

The light emitting unit according to the embodiment shown in FIGS. 3 and 4 has the extension formed integrally with the light emitting unit. As a result, when contact-type image sensors with differently shaped heat dissipating plates (contact-type image sensors with heat dissipating plates having the shapes shown in FIGS. 10 to 13 and FIG. 16, for example) are manufactured, it is necessary to manufacture light emitting units with differently shaped heat dissipating plates. However, using the light emitting unit according to the embodiment shown in FIG. 7, in which the heat dissipating plate is removable, allows a light emitting unit of the same design to be commonly used by preparing heat dissipating plates having different shapes. The manufacturing cost can thus be reduced.

The light emitting elements 25, 26, and 27 are mounted on the lead frame 23 in FIG. 8(a), whereas the light emitting elements are mounted on a lead frame A different from the lead frame 23 in the variation shown in FIG. 8(b). The lead frame A is spatially apart from the lead frame 23 and the lead terminals 22. The lead frame A dissipates heat to the heat dissipater 30 shown in FIG. 7 via the metallic piece 32. In the thus configured variation shown in FIG. 8(b), the heat generated in all the RGB elements is released to the heat dissipater 30. Alternatively, the heat generated in part of the elements may be released to the heat dissipater 30, whereas the heat generated in the other elements may be dissipated to the sensor substrate via the lead terminals 22. Specifically, for example, only the R element can be mounted on the lead frame 23, and the GB elements can be mounted on the lead frame A.

FIG. 9 shows lead frames used in the light emitting unit according to the present embodiment before they are cut off. As seen from FIG. 9, a large number of lead frames are cut out from a single material piece, whereby wasted material can be reduced.

FIGS. 10 to 13 show examples in which the heat dissipater is disposed along the housing case for the contact-type image sensor or the heat dissipater protrudes from the housing case. In the example shown in FIG. 10, the heat dissipater 30 on the upper surface of the housing case 3 is folded onto the lateral side surface so that the heat dissipater 30 extends along the side surface.

In the example shown in FIG. 11, a cutout 3c having a predetermined depth measured from the upper surface of the housing case 3 is formed. The heat dissipater 30 extends through the cutout 3c, and the heat dissipater 30 on the longitudinal side surface of the housing case 3 is folded onto the lateral side surface so that the heat dissipater 30 extends along the side surface.

In the example shown in FIG. 12, a cutout 3c having a predetermined depth measured from the upper surface of the housing case 3 is formed. The heat dissipater 30 extends through the cutout 3c, and is folded onto the longitudinal side surface of the housing case 3 so that the heat dissipater 30 extends along the side surface.

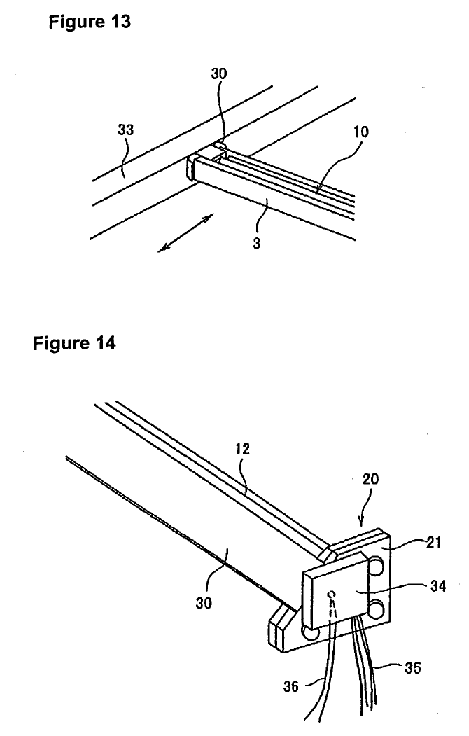

In the example shown in FIG. 13, the heat dissipater 30 is curved outward from an end of the housing case 3 to form a protruding shape having a spring capability. The heat dissipater 30 is slidably brought into contact with a metallic frame 33 of the image scanner. Heat is thus released to the metallic frame 33 through the heat dissipater 30.

FIG. 14 is a perspective view of a linear illumination device according to another example in which a heater 34 is attached to the outer surface of a resin mold 21 of a light emitting unit 20, and power feeding lead wires 35 and a thermocouple 36 are connected to the heater 34. The heater 34 can quickly increase the temperature of the light emitting unit 20 to achieve the state of equilibrium for stable light emission.

That is, light emitting elements in the light emitting unit 20, when energized, always generate heat. The generated heat is released via the heat dissipater 30, so that the light emission efficiency can be enhanced. Providing the heat dissipater 30 effectively cools the light emitting elements, and hence it takes time to increase the temperature of the light emitting elements to an equilibrium temperature. The fact that the light emitting elements operate at low temperatures is preferable if only light emission efficiency is considered, but the temperature is preferably fixed in order to achieve stable light emission with constant luminance. To this end, the heater 34 is used to quickly increase the temperature of the light emitting elements to a relatively low equilibrium temperature for stable light emission.

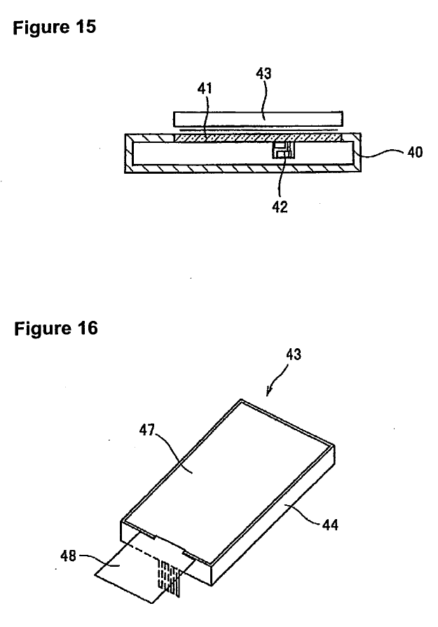

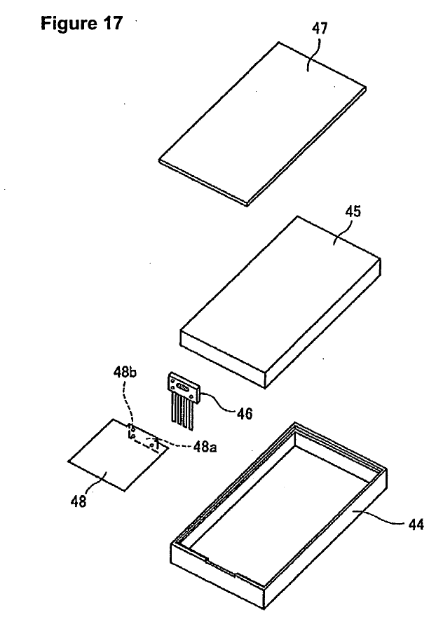

FIGS. 15 to 18 show an image scanner according to another example using a panel illumination device and the structure of the panel illumination device.

As shown in FIG. 15, the image scanner using a panel illumination device is configured in the following manner: A source document glass 41 fits in an opening in the upper surface of a housing 40. A contact-type image sensor unit 42 is disposed in the housing 40 in such a way that the image sensor unit 42 can move in a reciprocating manner. Further, a panel illumination device 43 is disposed above the source document glass 41, so that a light-transmitting source document placed on the source document glass 41 is irradiated with light.

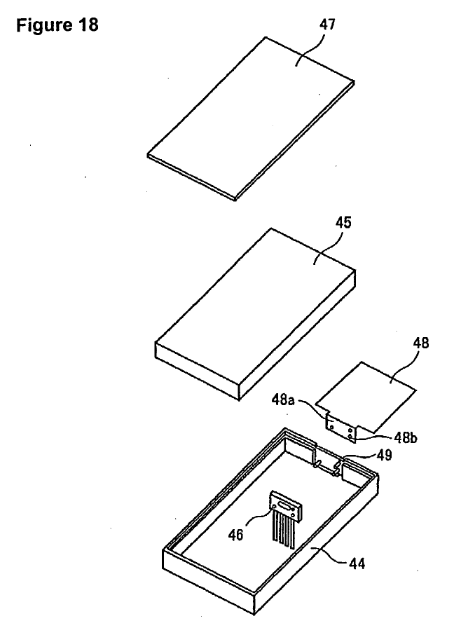

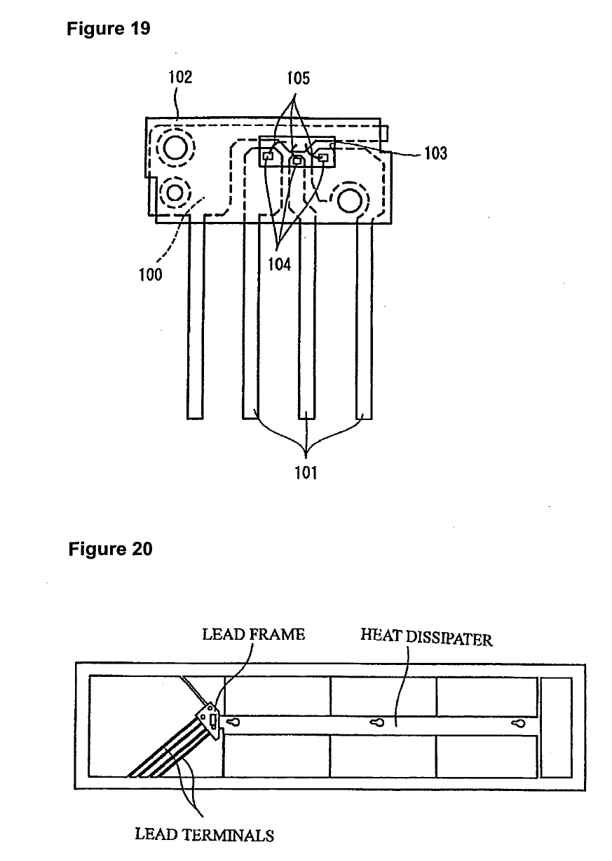

In the panel illumination device 43, as shown in FIGS. 16 and 18, a plate-shaped light guiding member 45 is housed in a case 44. A light emitting unit 46 is attached to one end of the light guiding member 45. A diffuser sheet 47 that reflects (scatters) the light from the light emitting unit 46 toward an exit surface is glued on the rear surface of the light guiding member 45 that is the side opposite the exit surface facing the source document glass. Further, a heat dissipater 48 is provided between the outer surface of the light emitting unit 46 and the case 44.

That is, pins 49 for positioning and securing the light emitting unit 46 are provided on the inner surface of the case 44. On the other hand, part of the heat dissipater 48 forms a folded portion 48a. Holes 48b are formed in the folded portion 48a in the positions that correspond to the pins 49. The pins 49 are inserted into the holes 48b of the folded portion 48a of the heat dissipater 48. Further, the light emitting unit 46 is aligned with the pins 49 and fixed. In this state, the light guiding member 45 is housed in the case 44. The folded portion 48a is thus directly connected to a lead frame in the light emitting unit 46, and the heat generated in the light emitting unit 46 is transferred to the heat dissipater 48 via the lead frame.

Alternatively, the folded portion 48a may be bonded to the lead frame using a metallic member or a good thermally conductive adhesive.

The best mode for carrying out a second aspect of the present invention will be described below in detail with reference to the drawings. In the following description, the portions having the same functions as those in the first aspect have the same reference characters, and no redundant description thereof will be made.

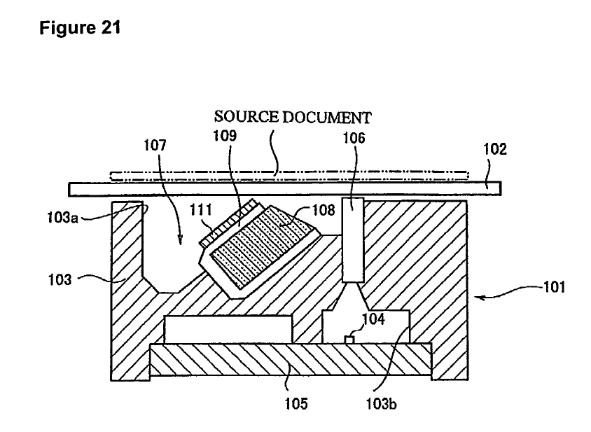

In FIG. 21, reference numeral 101 denotes a contact-type image sensor, and reference numeral 102 denotes a glass platen on which a source document is placed. The contact-type image sensor 101 moves parallel to the glass platen 102 and reads the source document. The direction in which the contact-type image sensor 101 moves is the sub scanning direction, and the direction perpendicular to the image sensor moving direction (the longitudinal direction of the contact-type image sensor 101) is the main scanning direction.

The contact-type image sensor includes a housing case (enclosure) 103 in which recesses 103a and 103b are formed. A linear illumination device 107 is disposed in one of the recesses 103a, and a sensor substrate 105 with a photoelectric conversion element (linear image sensor) 104 is attached to the other recess 103b. The housing case 103 further holds a unit magnification imaging lens array 106.

The linear illumination device 107 includes a rod-shaped or plate-shaped, transparent light guiding member 108 made of an acrylic resin that is housed in a white case 109 and a light emitting unit 110 attached to an end of the case 109. In the illustrated example, the light emitting unit 110 is attached to one end of the case 109, but two light emitting units 110 may be attached to both ends of the case 109. The linear illumination device 107 may also be disposed on each of the right and left sides of the lens array 106.

In the configuration described above, light emitted from the light emitting unit 110 is repeatedly reflected in the transparent light guiding member 108, exits through an exit surface of the linear illumination device 107, and illuminates the source document. The light reflected off the source document passes through the lens array 106 and other optical components and is detected by the photoelectric conversion element (linear image sensor). One line of the source document image is thus read. The contact-type image sensor can then be moved in the sub scanning direction to read the entire source document image.

In the above description, the same advantageous effect can be obtained by using a panel illumination device instead of the linear illumination device 107. It is therefore conceivable that the linear illumination device 7 is replaced with a panel illumination device.

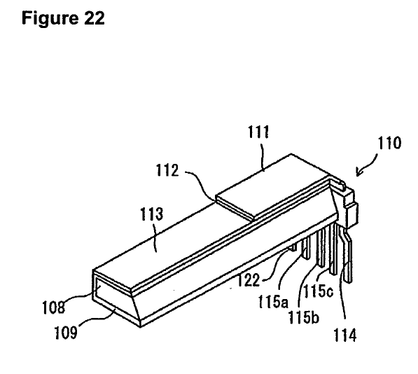

FIG. 22 shows the light emitting unit 110 according to the second aspect of the present invention. A heat dissipating plate 113 is attached to the case 109 with a thermally conductive insulating layer 112 interposed between the heat dissipating plate 113 and a lead frame 111 of the light emitting unit 110. Further, the anode terminals (common) 114, 122, and the cathode terminal (blue) 115a, the cathode terminal (red) 115b, and the cathode terminal (green) 115c of the light emitting unit 110 are implemented.

A preferable material of the lead frame 111 is phosphor bronze or iron-containing copper. The lower ends of the anode terminals 114, 122 are soldered into through holes formed in the sensor substrate 105 and connected to the anode terminal of a power supply.

Now, thermal conductivity is determined as the product of heat capacity per unit volume and thermal diffusivity, and the heat capacity is proportional to the thickness because the thermal conductivity represents the amount of heat transferred through a unit area in a unit period. For example, assuming that the thermal conductivity of the lead frame 111 is 390 W/m·K and the thermal conductivity of the thermally conductive insulating layer 112 is 60 W/m·K, for example, when a silicon grease WW-7762 made by Shin-Etsu Chemical Co., Ltd. is used, the ratio of the thermal conductivity of a lead frame 111a to the thermal conductivity of the thermally conductive insulating layer 112 is 390/60=6.5. Therefore, setting the ratio of the thickness of the lead frame 111a to the thickness of the thermally conductive insulating layer 112 to 1:6.5 allows the amount of heat that the lead frame 111 receives to be entirely transferred to the thermally conductive insulating layer 112. The same argument applies to the relationship between light emitting elements 110a to 110c mounted on the lead frame (heat transfer portion) 111a and the lead frame (heat transfer portion) 111a. The plate thickness of the lead frame 111a depends on the period and frequency of the event of actually conducting current having at least a rated value through the light emitting unit, and it is necessary to set the thickness of the lead frame (heat transfer portion) 111a to a value at which the junction temperature of the light emitting elements (LEDs) can always be kept at a temperature in a rated temperature range.

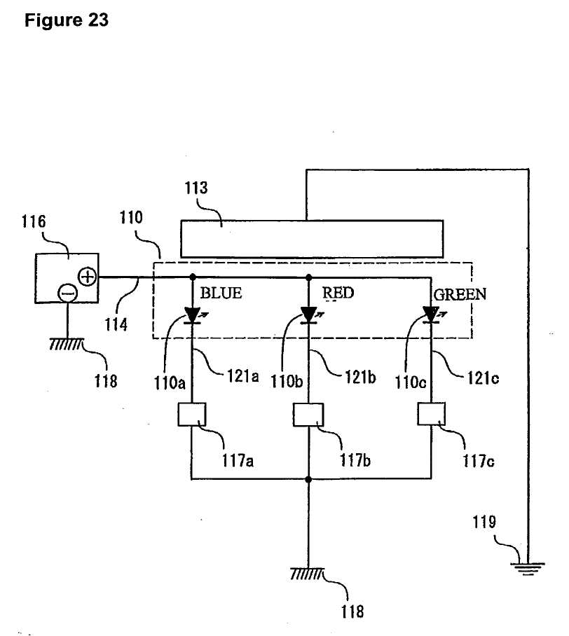

In FIG. 23, three light emitting elements are housed in the light emitting unit 110: a light emitting element (blue) 110a, a light emitting element (red) 110b, and a light emitting element (green) 110c. The light emitting elements are connected in the common anode configuration; specifically the anodes 114 are connected to the anode terminal of a power supply 116. The cathodes of the light emitting element (blue) 110a, the light emitting element (red) 110b, and the light emitting element (green) 110c are connected to a current control circuit (blue) 117a, a current control circuit (red) 117b, and a current control circuit (green) 117c, respectively. Each of the current control circuits conducts current controlled to have a predefined value through the corresponding light emitting element. The ground terminals of the electric circuits, the current control circuit (blue) 117a, the current control circuit (red) 117b, and the current control circuit (green) 117c, are connected to a common signal ground 118, so that the ground terminals and the signal ground 118 have the same potential.

On the other hand, the heat dissipating plate 113 is provided separately from the light emitting unit 110, and grounded to a frame ground 119. The heat dissipating plate 113 abuts the lead frame (heat dissipater) 111 via the thermally conductive insulating layer 112 shown in FIG. 22, and the lead frame (heat dissipater) 111 absorbs heat generated in the light emitting element (blue) 110a, the light emitting element (red) 110b, and the light emitting element (green) 110c via the lead frame (heat transfer portion) 111a and dissipates the heat into the air.

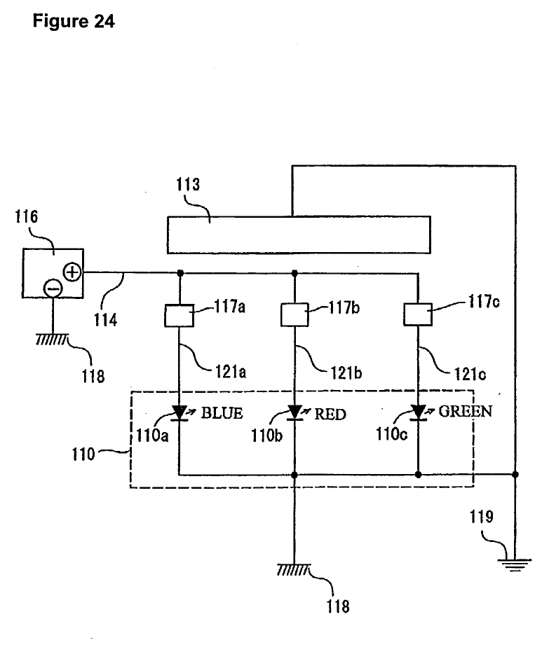

FIG. 24 is another example of the second aspect of the present invention in which the frame ground 118 is electrically connected to the system ground 119 so that the two grounds have the same potential. The frame ground 118 and the system ground 119 are connected to the ground terminals of the heat dissipating plate 113 and electric circuits, the current control circuit (blue) 117a, the current control circuit (red) 117b, and the current control circuit (green) 117c. In this way, static electricity and other noise, if introduced into the heat dissipating plate 113, flow out to the frame ground 119, whereby there is no risk of breaking the LEDs and no possibility of affecting a CIS signal from a contact-type image sensor.

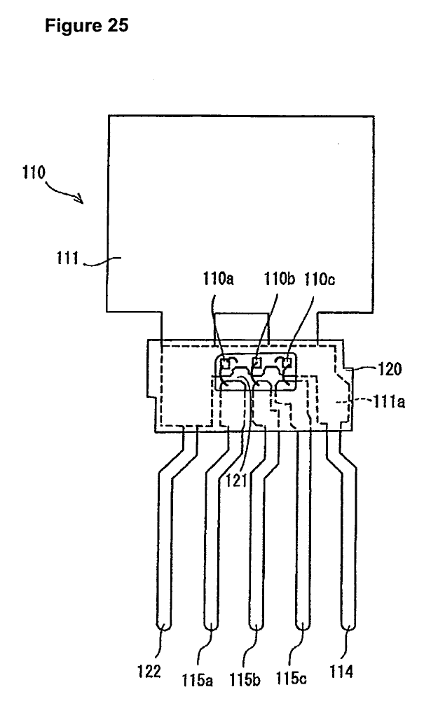

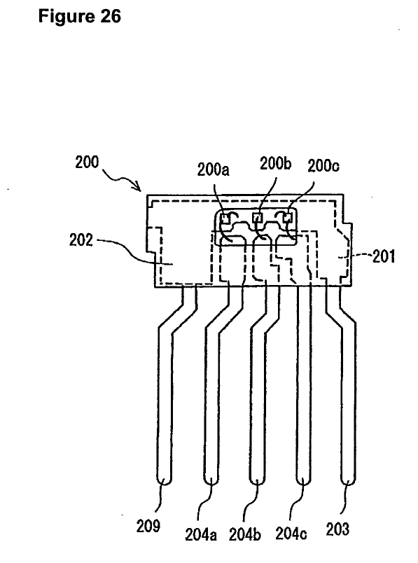

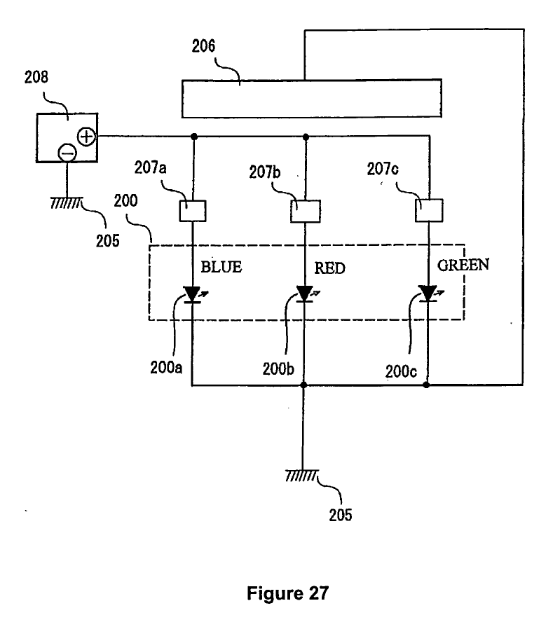

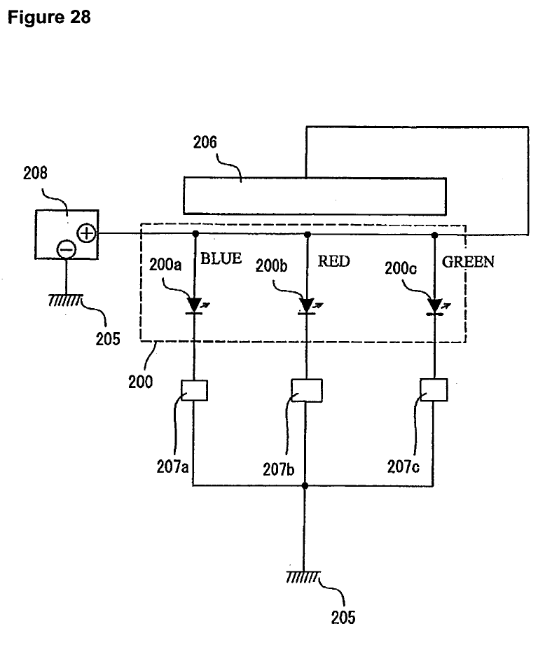

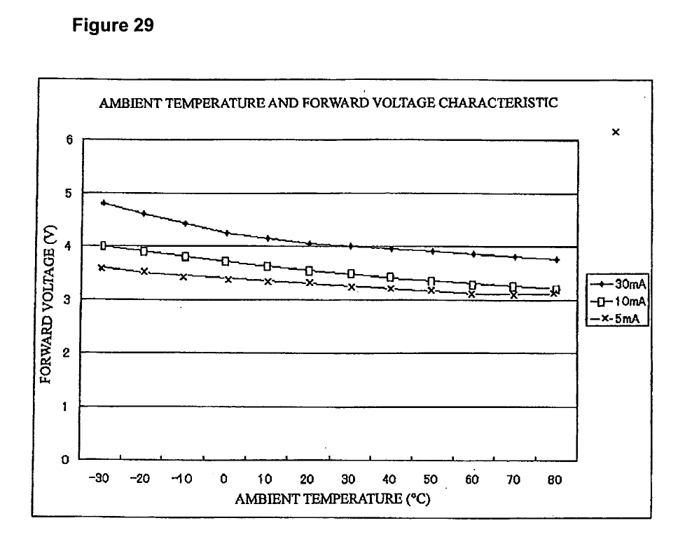

FIG. 25 shows the structure of the light emitting unit 110 according to the second aspect of the present invention. The lead frame (heat transfer portion) 111a is fabricated by forming a resin mold 120 with cathode terminals 115a, 115b, and 115c inserted therein, and the lead frame 111a has a window 121 through which the light emitting elements are mounted. When the linear illumination device described above is moved in the sub scanning direction to read the entire source document image, heat generated in the light emitting element (blue) 110a, the light emitting element (red) 110b, and the light emitting element (green) 110c is directly transferred to the lead frame (heat transfer portion) 111a, propagated from the lead frame (heat transfer portion) 111a through the lead frame (heat dissipater) 111 to the thermally conductive insulating layer 112 shown in FIG. 22, and dissipated from the heat dissipating plate 113 into the air.

1. A light emitting unit comprising:
a lead frame on which a light emitting element is mounted, the lead frame including a part held in a resin mold; and
a heat dissipater that releases heat generated when the light emitting element is energized,
wherein the heat dissipater is formed separately from the lead frame, and
the heat dissipater is connected to the lead frame directly or via a metallic member.

2. The light emitting unit according to claim 1, wherein the heat dissipater is connected to the lead frame or the metallic member mechanically or via a thermally conductive resin sheet, grease, or adhesive.

3. A light emitting unit comprising:
a lead frame on which a light emitting element is mounted, the lead frame including a part held in a resin mold;
a heat dissipater that releases heat generated when the light emitting element is energized, and
a heater disposed in the vicinity of the light emitting element, the heater quickly increasing a junction temperature of the light emitting element to an equilibrium temperature.

4. The light emitting unit according to claim 1, wherein the metallic member is attached to a side of the lead frame that is opposite a portion on which the light emitting element is mounted, and
the metallic member is exposed to the outside through a hole formed in the resin mold.

5. A linear or panel illumination device comprising the light emitting unit according to claim 1.

6. A linear or panel illumination device comprising the light emitting unit according to claim 1 disposed at an end of a light guiding member, wherein the heat dissipater is disposed along a case for the light guiding member.

7. A contact-type image sensor comprising a linear illumination device having the light emitting unit according to claim 1.

8. A reduction-type image scanner comprising a linear illumination device having the light emitting unit according to claim 1.

9. An image scanner comprising the contact-type image sensor according to claim 7.

10. A contact-type image sensor comprising:
a linear illumination device having the light emitting unit according to claim 1 disposed at an end of a light guiding member;
a linear image sensor; and
a lens array that focuses light reflected off or transmitted through a source document onto the linear image sensor,
wherein the linear illumination device, the linear image sensor, and the lens array are assembled in a housing case,
the housing case is moved parallel to the source document to read the source document, and
the heat dissipater is disposed along the housing case.

11. An image scanner comprising:
a linear illumination device having the light emitting unit according to claim 1 disposed at an end of a light guiding member;
a linear image sensor; and
a lens array that focuses light reflected off or transmitted through a source document onto the linear image sensor,
wherein the linear illumination device, the linear image sensor, and the lens array are assembled in a housing case,
the housing case is moved parallel to the source document to read the source document, and
the heat dissipater protrudes outward from the housing case and is slidably brought into contact with a frame of the image scanner.

12. A light emitting unit comprising:
a lead frame on which at least one light emitting element is mounted; and
a heat dissipater that releases heat generated when the light emitting element is energized,
wherein the heat dissipater is directly connected to a frame ground provided separately from a signal ground.

13. A light emitting unit comprising:
a lead frame on which at least one light emitting element is mounted; and
a heat dissipater that releases heat generated when the light emitting element is energized,
wherein the light emitting element is connected to a power supply in a common anode configuration,
a cathode of the light emitting element is connected to a current control circuit grounded to a signal ground,
the heat dissipater is attached to a thermally conductive insulating layer that is then attached to the lead frame on which the light emitting element is mounted, and
the dissipater is connected to a frame ground electrically insulated from the signal ground.

14. The light emitting unit according to claim 12, wherein the heat dissipater is formed separately from the lead frame, and
the heat dissipater is connected to the lead frame via a thermally conductive insulating member.

15. A linear or panel illumination device comprising the light emitting unit according to claim 12.

16. A contact-type image sensor comprising the linear illumination device according to claim 15.

17. A reduction-type image scanner comprising the linear illumination device according to claim 15.

18. An image scanner comprising the contact-type image sensor according to claim 16.
